(19) United States
(12) Patent Application Publication
(10) Pub. No.: US 2009/0100482 A1
(43) Pub. Date: Apr. 16, 2009

(54) Conveyance of Concatenation Properties and Picture Orderness in a Video Stream

(76) Inventors: Arturo A. Rodriguez, Norcross, GA (US); James Au, Richmond (CA)

Correspondence Address: THOMAS, KAYDEN, HORSTEMEYER & RISLEY;SCIENTIFIC ATLANTA, A CISCO COMPANY, 600 GALLERIA PKWY SE, SUITE 1500, ATLANTA, GA, 30339-5994, US

(21) Appl. No.: 12/252,632

(22) Filed: Oct. 16, 2008

Related U.S. Application Data
(60) Provisional application No. 60/980,442, filed on Oct. 16, 2007.

(51) Int. Cl. H04N 7/173

(52) U.S. Cl. 725/105

(57) ABSTRACT

Systems and methods that provide a video stream including a first video sequence followed by a second video sequence, and that provide a first information in the video stream pertaining to pictures in the first video sequence, wherein the location of the first information provided in the video stream is in relation to a second information in the video stream, wherein the second information pertains to the end of the first video sequence, wherein the first information in the video stream corresponds to a first information type and the second information in the video stream corresponds to a second information type different than the first information type, and wherein the first information corresponds to auxiliary information.

### CROSS-REFERENCE TO RELATED APPLICATIONS

This application claims priority to copending U.S. provisional application entitled, “SPLICING AND PROCESSING VIDEO AND OTHER FEATURES FOR LOW DELAY,” having Ser. No. 60/980,442, filed Oct. 16, 2007, which is entirely incorporated herein by reference.

This application is related to copending U.S. utility application entitled, “INDICATING PICTURE USEFULNESS FOR PLAYBACK OPTIMIZATION,” having Ser. No. 11/831,916, filed Jul. 31, 2007, which is entirely incorporated herein by reference. Application Ser. No. 11/831,916 has also published on May 15, 2008 as U.S. Patent Publication No. 20080115176A1.

### TECHNICAL FIELD

Particular embodiments are generally related to processing of video streams.

### BACKGROUND

Broadcast and On-Demand delivery of digital audiovisual content has become increasingly popular in cable and satellite television networks (generally, subscriber television networks). Various specifications and standards have been developed for communication of audiovisual content, including the MPEG-2 video coding standard and AVC video coding standard. One feature pertaining to the provision of programming in subscriber television systems requires the ability to concatenate video segments or video sequences, for example, as when inserting television commercials or advertisements. For instance, for local advertisements to be provided in national content, such as ABC news, etc., such programming may be received at a headend (e.g., via a satellite feed), with locations in the programming allocated for insertion at the headend (e.g., headend encoder) of local advertisements. Splicing technology that addresses the complexities of AVC coding standards is desired.

### BRIEF DESCRIPTION OF THE DRAWINGS

Many aspects of the disclosure can be better understood with reference to the following drawings. The components in the drawings are not necessarily to scale, emphasis instead being placed upon clearly illustrating the principles of the disclosed embodiments. Moreover, in the drawings, like reference numerals designate corresponding parts throughout the several views.

FIG. 1 is a functional block diagram that illustrates an embodiment of a video stream emitter in communication with a video stream receive and process device.

FIGS. 2A-2C are block diagrams that illustrates the signaling of information in a video stream.

FIG. 3 is a flow diagram that illustrates one method embodiment employed by the video stream emitter of FIG. 1.

FIG. 4 is a flow diagram that illustrates another method embodiment employed by the video stream emitter of FIG. 1.

FIG. 5 is a flow diagram that illustrates another method embodiment employed by the video stream emitter of FIG. 1.

### DESCRIPTION OF EXAMPLE EMBODIMENTS

### Overview

Systems and methods that, in one embodiment, provide a video stream including a portion containing a first video sequence followed by a second video sequence, and that provide a first information in the video stream pertaining to pictures in the first video sequence, wherein the location of the first information provided in the video stream is in relation to a second information in the video stream, wherein the second information pertains to the end of the first video sequence, wherein the first information in the video stream corresponds to a first information type and the second information in the video stream corresponds to a second information type different than the first information type, and wherein the first information corresponds to auxiliary information.

### Example Embodiments

In general, certain embodiments are disclosed herein that illustrate systems and methods (collectively, also referred to as video stream emitter) that provides a video stream (e.g., bitstream) that includes one or more concatenated video sequences (e.g., segments) and information pertaining to the one or more concatenations to other devices, such as one or more receivers coupled over a communications medium. The video stream emitter may include video encoding capabilities (e.g., an encoder or encoding device) and/or video splicing capabilities (e.g., a splicer). In one embodiment, the video stream emitter receives a video stream including a first video sequence and splices or concatenates a second video sequence after a potential splice point in the first video sequence. The potential splice point in the first video sequence is identified by information in the video stream, said information having a corresponding information type, such as a message. The video stream emitter may include information in the video stream that pertains to the concatenation of the first video sequence followed by the second video sequence. Included information may further provide information pertaining to the concatenation, such as properties of the pictures of the first video sequence and of pictures of the second video sequence.

In another embodiment, the video stream emitter receives a video stream including a first video sequence and replaces a portion of the first video sequence with a second video sequence by effectively performing two concatenations, one from the first video sequence to the second video sequence, and another from the second video sequence to the first video sequence. The two concatenations correspond to respective potential splice points, each identified in the video stream by information in the video stream having a corresponding information type. The video stream emitter may include information in the video stream that pertains to each respective concatenation of one of the two video sequences followed by the other of the two video sequences. Included information may further provide properties of pictures at the two adjoined video sequences.

An encoder, possibly in the video stream emitter, may inserts information in the video stream corresponding respectively to each of one or more potential splice points in the video stream, allowing for each of the one or more potential splice points to be identified by the splicer. Information provided by the encoder may further provide properties of one or more potential splice points, in a manner as described below.

It should be understood that terminology of the published ITU-T H.264/AVC standard is assumed.

Further, the MPEG-2 video coding standard can be found in the following publication, which is hereby incorporated by reference: (1) ISO/IEC 13818-2, (2000), “Information Technology—Generic coding of moving pictures and associated audio—Video.” A description of the AVC video coding standard can be found in the following publication, which is hereby entirely incorporated by reference: (2) ITU-T Rec. H.264 (2005), “Advanced video coding for generic audiovisual services.”

Additionally, it should be appreciated that certain embodiments of the various systems and methods disclosed herein are implemented at the video stream layer (as opposed to the system or MPEG transport layer).

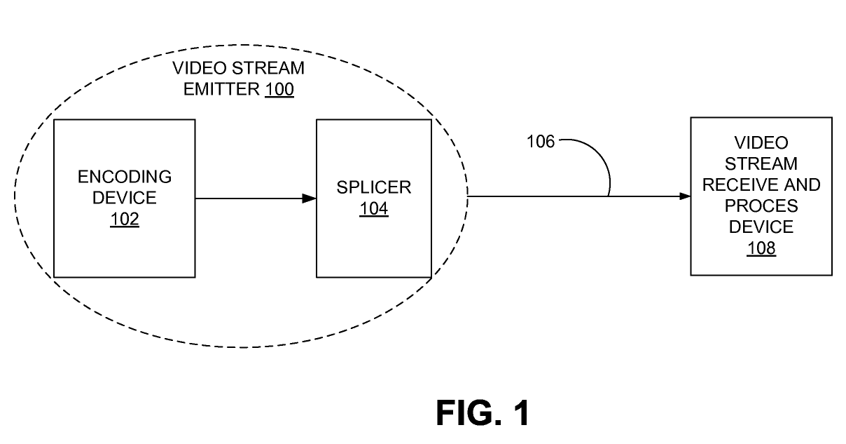

FIG. 1 is a block diagram that depicts an example video stream emitter 100 that provides a video stream over a communications medium 106, which can be a bus or component conducting medium, or in some embodiments, can be a medium corresponding to a local or wide area network in wired or wireless form. The video stream emitter 100 comprises one or more devices that, in one embodiment, can logically, physically, and/or functionally be divided into an encoding device 102 and a splicer or concatenation device 104. In an alternate embodiment, the encoding device 102 is external to the video stream emitter 100, which receives a video stream containing a first video sequence that is provided by the encoder 102. Hence, the encoding device 102 and splicer 104 can be co-located in the same premises (e.g., both located in a headend or hub, or at different locations, such as when the encoding device 102 is upstream from the splicer 104 in a video distribution network). In some embodiments, the encoding device 102 and splicer 104 may be separately located such as distributed in a server-client relationship across a communications network. The encoding device 102 and/or splicer 14 are configured to provide a compressed video stream (e.g., bitstream) comprising one or more video sequences, and insert information according to the respective information type corresponding to the information. For example, auxiliary information or messages, such as Supplemental Enhanced Information (SEI) messages, in the video stream may be provided by the encoder 102 and intended to assist the splicer 104 and/or a video stream receive and process device (VSRAPD) 108. However, it should be noted that the splicer 104 may opt to ignore this auxiliary information. Such inserted (e.g., auxiliary) information is provided in the video stream according to its corresponding information type (e.g., an SEI message) and assists the splicer 104 in concatenating the video sequences of the video stream. For instance, such auxiliary information in the video stream may provide location information pertaining to potential splice points in the video stream, as described further below. For instance, one of the potential splice points may identify a location in the video stream where an advertisement or commercial may be inserted.

The video stream emitter 100 and its corresponding components are configured in one embodiment as a computing device or video processing system or device. The encoding device 102 and/or splicer 104, for instance, can be implemented in software (e.g., firmware), hardware, or a combination thereof.

The video stream emitter 100 outputs plural video sequences of a video stream to the VSRAPD 108 over a communications medium (e.g., HFC, satellite, etc.), which in one embodiments may be part of a subscriber television network. The VSRAPD 108 receives and processes (e.g., decodes and outputs) the video stream for eventual presentation (e.g., in a display device, such as a television, etc.). In one embodiment, the VSRAPD 108 can be a set-top terminal, cable-ready television set, or network device.

The one or more processors that make up the encoding device 102 and splicer 104 of the video stream emitter 100 can each be configured as a hardware device for executing software, particularly that stored in memory or memory devices. The one or more processors can be any custom made or commercially available processor, a central processing unit (CPU), a graphics processing unit, a programmable DSP unit, an auxiliary processor among several processors associated with the encoding device 102 and splicer 104, a semiconductor based microprocessor (in the form of a microchip or chip set), a macroprocessor, or generally any device for executing software instructions. Any processor capable of executing a set of instructions (sequential or otherwise) that specify actions to be taken are included.

The memory or memory devices can include any one or combination of volatile memory elements (e.g., random access memory (RAM, such as DRAM, SRAM, SDRAM, etc.)) and nonvolatile memory elements (e.g., ROM, hard drive, tape, CDROM, etc.). Moreover, the memory may incorporate electronic, magnetic, optical, and/or other types of storage media. Note that the memory can have a distributed architecture, where various components are situated remote from one another, but can be accessed by the respective processor.

The software in memory may include one or more separate programs, each of which comprises an ordered listing of executable instructions for implementing logical functions. When functionality of the encoding device 102 and/or splicer 104 is implemented in software, it should be noted that the software can be stored on any computer readable medium for use by or in connection with any computer related system or method.

In another embodiment, where the video stream emitter 100 is implemented in hardware, the encoding device 102 and splicer 104 can be implemented with any or a combination of the following technologies, which are each well known in the art: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc.

It should be appreciated in the context of the present disclosure that the video stream emitter functionality described herein is implemented in one embodiment as a computer-readable medium encoded with computer-executed instructions that when executed by one or more processors of an apparatus/device(s) cause the apparatus/device(s) to carry out one or more methods as described herein.

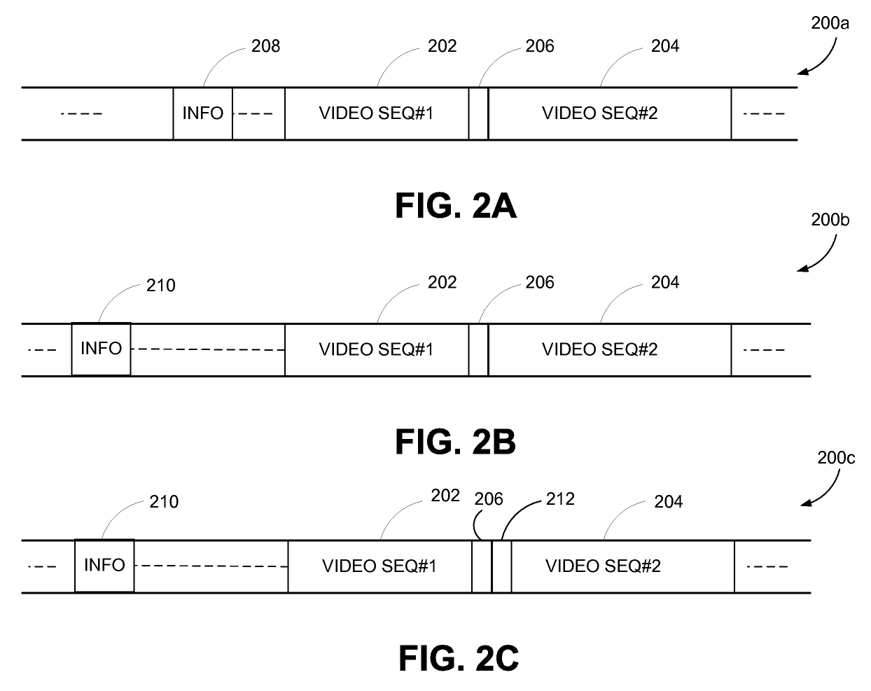

Having described an example video stream emitter 100, attention is directed to FIG. 2A, which is a block diagram that conceptually illustrates an example implementation involving the video stream emitter 100. In particular, FIG. 2A shows a video stream 200a that in one embodiment is provided by the video stream emitter 100. The video stream 200a comprises compressed pictures that includes a first video sequence 202 and a second video sequence 204. For instance, in one implementation, the first video sequence 202 is received at a receiver followed by the second video sequence 204. In one implementation, the end of the first video sequence 202 is delineated by information 206, such as an end_of_stream NAL Unit. The information 206 is provided in the video stream in accordance to its corresponding information type, a NAL unit. The information 206 is in the first video sequence 202 at the end of the first video sequence. In one embodiment, information 208 is provided in the video stream in relation to other information (e.g., an end_of_stream NAL Unit 206). Information 208 pertains to a concatenation in the video stream, particularly to the end of first video sequence 202 followed by the second video sequence 204. The information 208, in one embodiment, may identify the location and/or picture properties of information 206, which may correspond to a potential splice point. The information 206, may be an end_of_stream NAL Unit 206 in the video coding layer (VCL) inserted by the encoding device 102. The information 206 may be used by the splicer 104 to perform the concatenation of the first video sequence 202 and the second video sequence 204 and remain included in the video stream provided by the video stream emitter 100, which may then be also used by the VSRAPD 108. The splicer 104 may provide information 206 in some embodiments. The information 208 may be provided by the encoding device 102 to be used by the splicer 104. In one embodiment, this information 208 is inserted by the same concatenation or splicing device that inserts the end_of_stream NAL Unit or information 206. The information 208 may be provided in the video stream to point ahead to information 206, which identifies a potential splice point to the splicer 104, and identifies to the VSRAPD 108 a concatenation of the first video sequence 202 followed by the second video sequence 204.

Given that a compressed picture buffer (CPB) is subject to the initial buffering delay and offset, and the different treatment of non-VCL NAL units in different models, there is need to specify the effective time of the end_of_stream NAL Unit 206. One consideration for the effective time of the end_of_stream NAL Unit 206 is immediately prior to the picture that follows the last decoded picture prior (in relation to the end_of_stream NAL Unit); in other words, in the first video sequence 202 at the end of the first video sequence (or what would be the end of the first video sequence when indicated as a potential slice point). Note that the information 206 is immediately prior to the first picture of the second video sequence 204, as illustrated in FIG. 2A.

Note that one having ordinary skill in the art would recognize, in the context of the present disclosure, that since a sequence in AVC begins with an IDR picture, the end_of_stream NAL Unit 206 is not required in all implementations to indicate the end of the first video sequence 202. Thus, the end_of_stream NAL unit, or information 206, can be used by encoding device 102 to identify to the splicer 104 a location in the first video sequence that is suitable for concatenation (i.e., a potential splice point). Furthermore, the information 206 can be used to identify a location in the video stream to the VSRAPD 108 corresponding to a concatenation from the first video sequence 202 to the second video sequence 204.

In another embodiment, illustrated by the block diagram of FIG. 2B, information 210 and the end_of_stream NAL Unit 206 is signaled further ahead (e.g., temporally, such as earlier in comparison to information 208, or spatially prior) to allow sufficient lead time to the VSRAPD 108 (i.e., the decoder). For instance, the information 210 accompanying the end_of_stream NAL Unit 206 may indicate the exact number of pictures in the VCL from its location in the video stream after which the end_of_stream NAL Unit 206 is located to identify a potential splice point or where the concatenation occurs. Thus, the information 210 may be provided in the video stream to point ahead to information 206, which identifies a potential splice point to the splicer 104, and to the VSRAPD 108, a concatenation of the first video sequence 202 followed by the second video sequence 204. And the information 210 (or 208) may be used to indicate at the concatenation the properties of the pictures of the first video sequence 202 and possibly of the pictures of the second video sequence 204. Hence the information 210 may provide location information and/or property information pertaining to information 206.

In one embodiment, the effective time of the end_of_stream NAL Unit 206 can be understood in the following context:

second stream's (CPB delay+DPB delay) is<first stream's (CPB delay+DPB delay).

In one embodiment, it is beneficial if the same or different information (e.g., SEI message) further conveyed the output behavior of certain pictures of the first video sequence 202 in a decoded picture buffer (DPB) to properly specify a transition (e.g., a transition period) in which non-previously output pictures of the first video sequence 202 are output while pictures of the second video sequence 204 enter the CPB. Such behavior is preferably flexible to allow the specification of each non-previously output pictures in the DPB at the concatenation point to be output repeatedly for N output intervals, which gives the option to avoid a gap without outputting pictures, relieve a potential bump in the bit-rate, and extend some initial CPB buffering of the second video sequence 204. However, it should be noted that the encoding device 102 may opt to ignore providing this auxiliary information.

In one embodiment, the second and different auxiliary information 210 (e.g., different than 208) is beneficially used to signal a potential concatenation (or splice) point in the video stream 200 (e.g., 200a, 200b). In one version, the information conveys that M pictures away there is a point in the stream in which the DPB contains K non-previously output pictures with consecutive output times, which aids concatenation devices (e.g., the splicer 104) to identify points in the stream amenable for concatenation.

In another embodiment, auxiliary information conveys the maximum number of out-of-output-order pictures in a low delay (a first processing mode or low delay mode) stream that can follow an anchor picture. An anchor picture herein is defined as an I, IDR, or a forward predicted picture that depends only on reference pictures with output times that are in turn anchor pictures. Such a feature provided by this embodiment is beneficial for trick-modes in applications such as Video-on-Demand (VOD) and Personal Video Recoding (PVR).

In some embodiments, one or more of the above conveyed information can be complemented with provisions that extend the no_output_of_prior_pics_flag at the concatenation (or in some embodiments, the latter ability can stand alone). For instance, referring to FIG. 2C and the video stream 200c, information, such as information 212, is specified to enable the option to convey whether the no_output_of_prior_pics_flag, including its inference rules, are effective at the concatenation, which allows for the possibility of outputting pictures that have consecutive output times in the DPB (such pictures corresponding to the first video sequence 202) while pictures of the second video sequence 204 enter the CPB or are decoded and delayed for output. That is, this embodiment enables a transition or transition period at the concatenation of two streams, or of two video sequences in a video stream in accordance with the H.264/AVC semantics, so that non-previously output pictures of the first video sequence 202 are output while pictures of the second video sequence 204 are ingested. The information 212 is provided in the video stream in accordance with a corresponding information type (e.g., a flag in the video coding layer). Information 212 is in the second video sequence 204 at the start of the second video sequence.

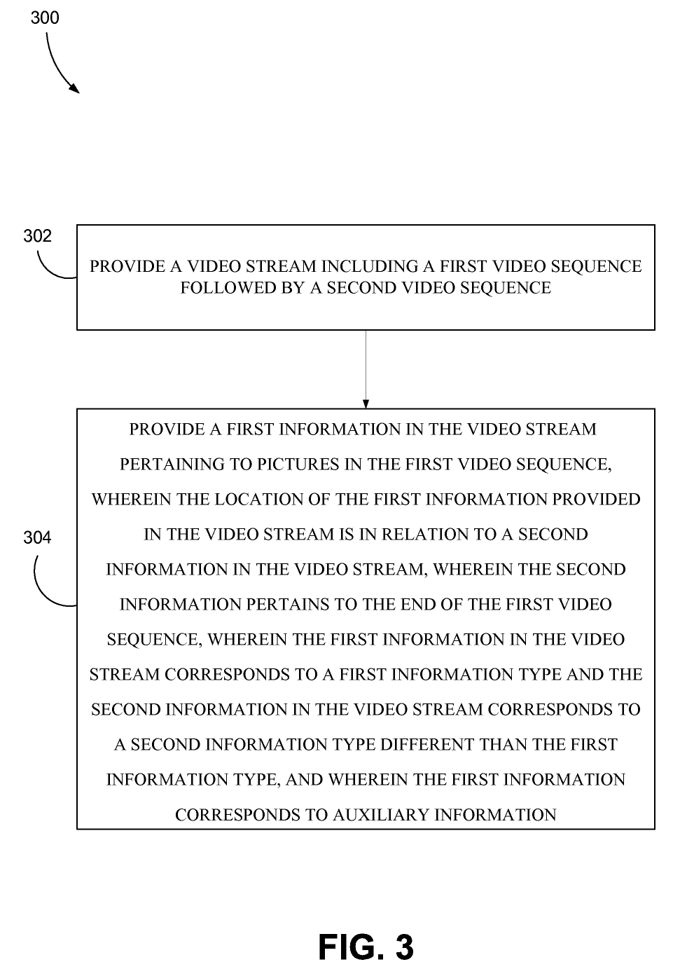

In view of the above-detailed description, it should be appreciated that one video stream emitter method embodiment, illustrated in FIG. 3 and designated method 300, comprises providing a video stream including a first video sequence followed by a second video sequence (302), and providing a second information in the video stream, wherein the second information specifies the output behavior of a first set of decoded pictures corresponding to the first video sequence, wherein a second set of pictures of the second video sequence corresponds to the first set of decoded pictures of the first video sequence, wherein the first information in the video stream corresponds to the end of the first video sequence (304).

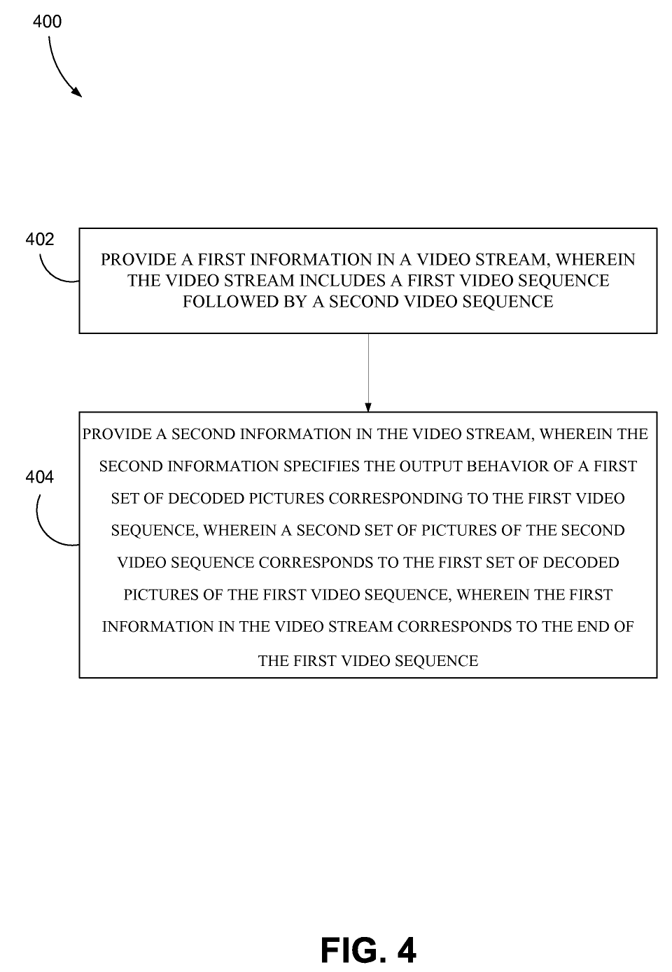

Another video stream emitter method embodiment, illustrated in FIG. 4 and designated method 400, comprises providing a first information in a video stream, wherein the video stream includes a first video sequence followed by a second video sequence (402), and providing a second information in the video stream, wherein the second information specifies the output behavior of a first set of decoded pictures corresponding to the first video sequence, wherein a second set of pictures of the second video sequence corresponds to the first set of decoded pictures of the first video sequence, wherein the first information in the video stream corresponds to the end of the first video sequence (404).

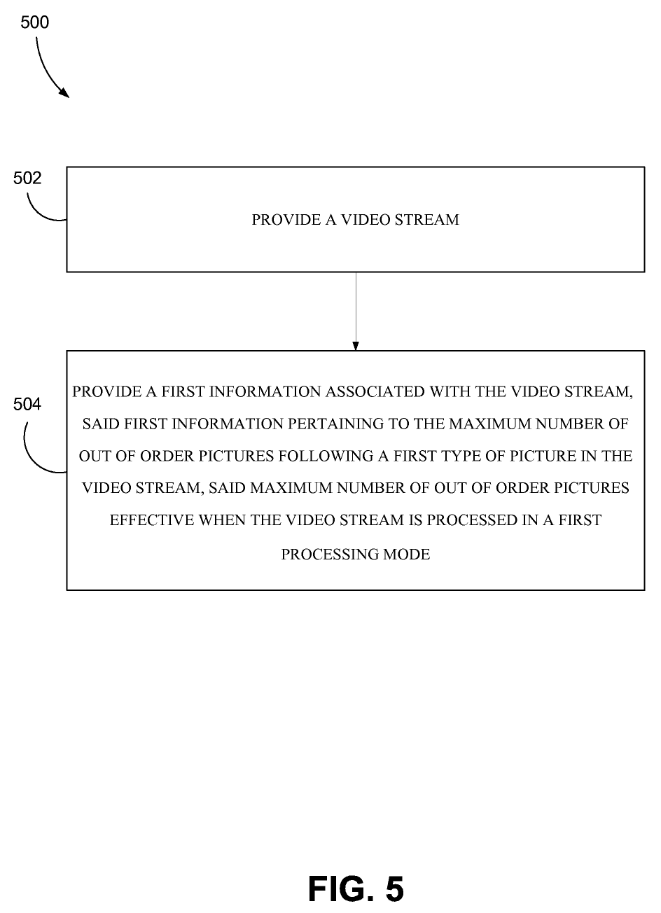

Another video stream emitter method embodiment, illustrated in FIG. 5 and designated method 500, comprises providing a video stream (502), and providing a first information associated with the video stream, said first information pertaining to the maximum number of out of order pictures following a first type of picture in the video stream, said maximum number of out of order pictures effective when the video stream is processed in a first processing mode (504).

It should be appreciated that the methods described above are note limited to the architectures shown in and described in association with FIG. 1. In some embodiments, the above-described methods may be employed exclusively by the encoding device 102, the splicer 104 in some embodiments, the VSRAPD 108 in some embodiments, or any combination of the three.

Further, it should be appreciated in the context of the present disclosure that receive and processing functionality is implied from the various methods described above.

In addition, it should be appreciated that although embodiments of the invention have been described in the context of the JVT and H.264 standard, alternative embodiments of the present disclosure are not limited to such contexts and may be utilized in various other applications and systems, whether conforming to a video coding standard, or especially designed. Furthermore, embodiments are not limited to any one type of architecture or protocol, and thus, may be utilized in conjunction with one or a combination of other architectures/protocols.

Unless specifically stated otherwise, as apparent from the following discussions, it is appreciated that throughout the specification discussions utilizing terms such as “processing,” “computing,” “calculating,” “determining” or the like, refer to the action and/or processes of a computer or computing system, or similar electronic computing device, that manipulate and/or transform data represented as physical, such as electronic, quantities into other data similarly represented as physical quantities.

In a similar manner, the term “processor” may refer to any device or portion of a device that processes electronic data, e.g., from registers and/or memory to transform that electronic data into other electronic data that, e.g., may be stored in registers and/or memory. A “computer” or a “computing machine” or a “computing platform” may include one or more processors.

Note that when a method is described that includes several elements, e.g., several steps, no ordering of such elements (e.g., steps) is implied, unless specifically stated.

The methodologies described herein are, in one embodiment, performable by one or more processors (e.g., of encoding device 102 and splicer 104 or generally, of the video stream emitter 100) that accept computer-readable (also called machine-readable) logic encoded on one or more computer-readable media containing a set of instructions that when executed by one or more of the processors carry out at least one of the methods described herein. The processing system further may be a distributed processing system with processors coupled by a network.

The term memory unit as used herein, if clear from the context and unless explicitly stated otherwise, also encompasses a storage system such as a disk drive unit. The processing system in some configurations may include a sound output device, and a network interface device.

The memory subsystem thus includes a computer-readable carrier medium that carries logic (e.g., software) including a set of instructions to cause performing, when executed by one or more processors, one of more of the methods described herein. The software may reside in the hard disk, or may also reside, completely or at least partially, within the RAM and/or within the processor during execution thereof by the computer system. Thus, the memory and the processor also constitute computer-readable carrier medium on which is encoded logic, e.g., in the form of instructions. Furthermore, a computer-readable carrier medium may form, or be includes in a computer program product.

In alternative embodiments, the one or more processors operate as a standalone device or may be connected, e.g., networked to other processor(s), in a networked deployment, the one or more processors may operate in the capacity of a server or a client machine in server-client network environment, or as a peer machine in a peer-to-peer or distributed network environment. The one or more processors may form a personal computer (PC), a tablet PC, a set-top box (STB), a Personal Digital Assistant (PDA), a cellular telephone, a web appliance, a network router, switch or bridge, or any machine capable of executing a set of instructions (sequential or otherwise) that specify actions to be taken by that machine.

Thus, one embodiment of each of the methods described herein is in the form of a computer-readable carrier medium carrying a set of instructions, e.g., a computer program that are for execution on one or more processors, e.g., one or more processors that are part of a video processing device. Thus, as will be appreciated by those skilled in the art, embodiments may be embodied as a method, an apparatus such as a special purpose apparatus, an apparatus such as a data processing system, a system, or a computer-readable carrier medium, e.g., a computer program product. The computer-readable carrier medium carries logic including a set of instructions that when executed on one or more processors cause a processor or processors to implement a method. Accordingly, embodiments of the present disclosure may take the form of a method, an entirely hardware embodiment, an entirely software embodiment or an embodiment combining software and hardware aspects. Furthermore, the present disclosure may take the form of carrier medium (e.g., a computer program product on a computer-readable storage medium) carrying computer-readable program code embodied in the medium.

The software may further be transmitted or received over a network via a network interface device. While the carrier medium is shown in an example embodiment to be a single medium, the term “carrier medium” should be taken to include a single medium or multiple media (e.g., a centralized or distributed database, and/or associated caches and servers) that store the one or more sets of instructions. The term “carrier medium” shall also be taken to include any medium that is capable of storing, encoding or carrying a set of instructions for execution by one or more of the processors and that cause the one or more processors to perform any one or more of the methodologies of the present disclosure. A carrier medium may take many forms, including but not limited to, non-volatile media, volatile media, and transmission media. Non-volatile media includes, for example, optical, magnetic disks, and magneto-optical disks. Volatile media includes dynamic memory, such as main memory.

Transmission media includes coaxial cables, copper wire and fiber optics, including the wires that comprise a bus subsystem. Transmission media also may also take the form of acoustic or light waves, such as those generated during radio wave and infrared data communications.

It will be understood that the steps of methods discussed are performed in one embodiment by an appropriate processor (or processors) of a processing (i.e., computer) system executing instructions stored in storage. It will also be understood that embodiments of the present disclosure are not limited to any particular implementation or programming technique and that the various embodiments may be implemented using any appropriate techniques for implementing the functionality described herein. Furthermore, embodiments are not limited to any particular programming language or operating system.

Reference throughout this specification to “one embodiment” or “an embodiment” means that a particular feature, structure or characteristic described in connection with the embodiment is included in at least one embodiment of the present disclosure. Thus, appearances of the phrases “in one embodiment” or “in an embodiment” in various places throughout this specification are not necessarily all referring to the same embodiment, but may. Furthermore, the particular features, structures or characteristics may be combined in any suitable manner, as would be apparent to one of ordinary skill in the art from this disclosure, in one or more embodiments.

Similarly it should be appreciated that in the above description of example embodiments of the disclosure, various features of the disclosure are sometimes grouped together in a single embodiment, figure, or description thereof for the purpose of streamlining the disclosure and aiding in the understanding of one or more of the various concepts. This method of disclosure, however, is not to be interpreted as reflecting an intention that the claims requires more features than are expressly recited in each claim. Furthermore, while some embodiments described herein include some but not other features included in other embodiments, combinations of features of different embodiments are meant to be within the scope of the invention, and form different embodiments, as would be understood by those in the art. For example, in the following claims, any of the claimed embodiments can be used in any combination.

Furthermore, some of the embodiments are described herein as a method or combination of elements of a method that can be implemented by a processor of a computer system or by other means of carrying out the function. Thus, a processor with the necessary instructions for carrying out such a method or element of a method forms a means for carrying out the method or element of a method. Furthermore, an element described herein of an apparatus embodiment is an example of a means for carrying out the function performed by the element for the purpose of carrying out one or more of the disclosed embodiments.

Rather, as the following claims reflect, various inventive features lie in less than all features of a single foregoing disclosed embodiment. Thus, the claims following the DESCRIPTION OF EXAMPLE EMBODIMENTS are hereby expressly incorporated into this DESCRIPTION OF EXAMPLE EMBODIMENTS, with each claim standing on its own as a separate embodiment of the disclosure.

Furthermore, while some embodiments described herein include some but not other features included in other embodiments, combinations of features of different embodiments are meant to be within the scope of the disclosure, and form different embodiments, as would be understood by those in the art. For example, in the following claims, any of the claimed embodiments can be used in any combination.

Furthermore, some of the embodiments are described herein as a method or combination of elements of a method that can be implemented by a processor of a computer system or device or by other means of carrying out the function. Thus, a processor with the necessary instructions for carrying out such a method or element of a method forms a means for carrying out the method or element of a method. Furthermore, an element described herein of an apparatus embodiment is an example of a means for carrying out the function performed by the element for the purpose of carrying out certain disclosed methods.

In the description provided herein, numerous specific details are set forth. However, it is understood that embodiments may be practiced without these specific details. In other instances, well-known methods, structures and techniques have not been shown in detail in order not to obscure an understanding of this description.

As used herein, unless otherwise specified the use of the ordinal adjectives “first”, “second”, “third”, etc., to describe a common object, merely indicate that different instances of like objects are being referred to, and are not intended to imply that the objects so described must be in a given sequence, either temporally, spatially, in ranking, or in any other manner.

Thus, while there has been described what are believed to be the preferred embodiments, those skilled in the art will recognize that other and further modifications may be made thereto without departing from the spirit of the disclosure, and it is intended to claim all such changes and modifications as fall within the scope of the embodiments. For example, any formulas given above are merely representative of procedures that may be used. Functionality may be added or deleted from the block diagrams and operations may be interchanged among functional blocks. Steps may be added or deleted to methods described within the scope of the present disclosure.

At least the following is claimed:

1. A method, comprising:
providing a video stream including a first video sequence followed by a second video sequence; and
providing a first information in the video stream pertaining to pictures in the first video sequence, wherein the location of the first information provided in the video stream is in relation to a second information in the video stream, wherein the second information pertains to the end of the first video sequence, wherein the first information in the video stream corresponds to a first information type and the second information in the video stream corresponds to a second information type different than the first information type, and wherein the first information corresponds to auxiliary information.

2. The method of claim 1, wherein the first information in the video stream pertaining to pictures in the first video sequence corresponds to the output time for one or more decoded pictures corresponding to the first video sequence.

3. The method of claim 2, wherein the first information further pertains to pictures in the second video sequence.

4. The method of claim 3, wherein the first information corresponds to a transition of outputting one or more decoded pictures of the first video sequence and decoding an equal number of one or more coded pictures from the second video sequence.

5. The method of claim 2, wherein the output times for the one or more pictures corresponds to consecutive picture output times.

6. The method of claim 1, wherein the second information pertaining to the end of the first video sequence is effective prior to the first picture in the second video sequence that follows the last picture of the first video sequence.

7. The method of claim 1, wherein the location of the second information pertaining to the end of the first video sequence is signaled in the video stream with a third information prior to the second information.

8. The method of claim 7, wherein the third information corresponds to the first information type.

9. The method of claim 1, wherein the sum of the compressed picture buffer delay and the decoded picture buffer delay corresponding to the second video sequence is less than the sum of the compressed picture buffer delay and the decoded picture buffer delay corresponding to the first video sequence.

10. The method of claim 1, further comprising providing a fourth information in the video stream pertaining to whether decoded pictures corresponding to the first video sequence should be output.

11. The method of claim 10, wherein the presence of the fourth information in the video stream affects a set of inference rules that would otherwise be effective without its presence.

12. A method, comprising:
providing a first information in a video stream, wherein the video stream includes a first video sequence followed by a second video sequence; and
providing a second information in the video stream, wherein the second information specifies the output behavior of a first set of decoded pictures corresponding to the first video sequence, wherein a second set of pictures of the second video sequence corresponds to the first set of decoded pictures of the first video sequence, wherein the first information in the video stream corresponds to the end of the first video sequence.

13. The method of claim 12, wherein the first information is provided after the end of the first video sequence.

14. The method of claim 13, wherein the second set of pictures of the second video sequence corresponds to pictures that enter a compressed picture buffer while the first set of decoded pictures of the first video sequence are output.

15. The method of claim 13, wherein the second information specifies repeating the output of at least one decoded picture corresponding to the first video sequence.

16. A method, comprising:
providing a video stream; and
providing a first information associated with the video stream, the first information pertaining to the maximum number of out of order pictures following a first type of picture in the video stream, the maximum number of out of order pictures effective when the video stream is processed in a first processing mode.

17. The method of claim 16, wherein the first type of picture corresponds to an intracoded picture.

18. The method of claim 16, wherein the first type of picture corresponds to a forward predicted picture, said forward predicted picture only referencing pictures that are intracoded pictures or other forward predicted pictures.

19. The method of claim 16, wherein the first processing mode corresponds to a low delay mode.

20. The method of claim 16, wherein the first type of picture corresponds to a set of pictures in the first processing mode that are output in the same order as they are decoded.

21. The method of claim 20, wherein the maximum number of pictures corresponds to the maximum number of pictures that are not output in the same order as they are decoded.
